(19) United States
(12) Patent Application Publication
(10) Pub. No.: US 2024/0153285 A1
(43) Pub. Date: May 9, 2024

(54) PREDICTION OF HUMAN SUBJECT STATE VIA HYBRID APPROACH INCLUDING AI CLASSIFICATION AND BLEPHAROMETRIC ANALYSIS, INCLUDING DRIVER MONITORING SYSTEMS

(71) Applicant: SDIP HOLDINGS PTY LTD, Richmond (AU)

(72) Inventors: Scott COLES, Waverton (AU); Trefor MORGAN, Hawthorn (AU)

(73) Assignee: SDIP HOLDINGS PTY LTD, Richmond (AU)

(21) Appl. No.: 18/568,865

(22) PCT Filed: Jun. 10, 2022
(86) PCT No.: PCT/AU2022/050575

§ 371 Date: Dec. 11, 2023

(30) Foreign Application Priority Data
Jun. 11, 2021 (AU) 2021901758

(51) Int. Cl. G06V 20/59; G06V 10/70; G06V 40/16; G06V 40/18; G06V 40/20; H04N 23/23

(52) U.S. Cl. CPC G06V 20/597; G06V 10/87; G06V 40/171; G06V 40/18; G06V 40/20; H04N 23/23

(57) ABSTRACT

The present invention relates, in various embodiments, to prediction of human subject states (e.g. physiological and/or psychological and/or neurological state) via a hybrid approach, which includes elements of AI-based classification and objective physiological analysis (such as blepharometric analysis). Embodiments are described by reference to applications in driver alertness monitoring. However, it will be appreciated that the technology is not limited as such, and has application in a broader range of context. For example, the technology is applicable to prediction of physiological states other than alertness level, and to implementation environments other than driver monitoring.

### FIELD OF THE INVENTION

The present invention relates, in various embodiments, to prediction of human subject states (e.g. physiological and/or psychological and/or neurological state) via a hybrid approach, which includes elements of AI-based classification and blepharometric analysis. Embodiments are described by reference to applications in driver alertness monitoring. However, it will be appreciated that the technology is not limited as such, and has application in a broader range of context. For example, the technology is applicable to prediction of physiological states other than alertness level, and to implementation environments other than driver monitoring.

### BACKGROUND

Any discussion of the background art throughout the specification should in no way be considered as an admission that such art is widely known or forms part of common general knowledge in the field.

Driver alertness monitoring systems are known in the art, and becoming increasing prevalent. Some modern systems have begun to integrate AI-based image classifiers as a means to predict driver alertness. Such systems use AI classifiers which are trained based on databases of facial images labelled based on alertness. In theory, this should allow the system to predict a driver's alertness state based on a facial image. However, there are complications with such systems, given that facial characteristics associated with alertness/drowsiness are variable across populations, with particular deviations between different races/ethnicities (and perhaps even cultures). Furthermore, there can be issues with labelling of data for training databases, given inherent complexities in labelling a particular image as being drowsy/alert based on visual inspection.

### SUMMARY OF THE INVENTION

It is an object of the present invention to overcome or ameliorate at least one of the disadvantages of the prior art, or to provide a useful alternative.

Example embodiments are described below in the sections entitled “detailed description” and “claims”.

One embodiment provides a method of predicting a state of a human subject, the method including capturing an image frame including a facial region of the subject; and
providing the image frame to an image classifier, wherein the image classifier is configured to process the image frame thereby to output a result representative of a predicted state;
wherein the image classifier is trained via a process including:
   gathering monitoring data from a plurality of subjects, wherein the monitoring data includes time correlated data representative of: (i) eyelid movement; and (ii) facial image data;
   processing the data representative of eyelid movement as a function of time thereby to predict respective states at a plurality of times (T₁ to Tₙ) based on eyelid movement analysis;
   labelling facial image data corresponding to the plurality of times (T₁ to Tₙ) with a value representative of the respective state predicted for each of the plurality of times (T₁ to Tₙ), thereby to define labelled facial image data; and
   providing the labelled facial image data to the image classifier as training data.

One embodiment provides a method of training a system configured to predict a state of a human subject, wherein the system is configured to perform a method including:
capturing an image frame including a facial region of the subject; and
providing the image frame to an image classifier, wherein the image classifier is configured to process the image frame thereby to output a result representative of a predicted state;
the method including:
   gathering monitoring data from a plurality of subjects, wherein the monitoring data includes time correlated data representative of: (i) eyelid movement; and (ii) facial image data;
   processing the data representative of eyelid movement as a function of time thereby to predict respective states at a plurality of times (T₁ to Tₙ) based on eyelid movement analysis;
   labelling facial image data corresponding to the plurality of times (T₁ to Tₙ) with a value representative of the respective state predicted for each of the plurality of times (T₁ to Tₙ), thereby to define labelled facial image data; and
   providing the labelled facial image data to the image classifier as training data.

One embodiment provides a method of assessing performance of a system configured to predict a state of a human subject, wherein the system is configured to perform a method including:
capturing an image frame including a facial region of the subject; and
providing the image frame to an image classifier, wherein the image classifier is configured to process the image frame thereby to output a result representative of a predicted state;
the method including:
   gathering monitoring data from a plurality of subjects, wherein the monitoring data includes time correlated data representative of: (i) eyelid movement; and (ii) facial image data;
   processing the data representative of eyelid movement as a function of time thereby to predict respective states at a plurality of times (T₁ to Tₙ) based on eyelid movement analysis;
   providing facial image data corresponding to the plurality of times (T₁ to Tₙ) to the image classifier, thereby to generate classifier predicted states at the plurality of times (T₁ to Tₙ);
   comparing the predicted respective states at a plurality of times (T₁ to Tₙ) based on blepharometric artefact analysis with the predicted states at the plurality of times (T₁ to Tₙ), thereby to assess performance of the system.

One embodiment provides a method of generating a data set for the purposes of training a classifier, the method including:
gathering monitoring data from a plurality of subjects, wherein the monitoring data includes time correlated data representative of: (i) eyelid movement; and (ii) facial image data;
processing the data representative of eyelid movement as a function of time thereby to predict respective states at a plurality of times (T₁ to Tₙ) based on eyelid movement analysis;
labelling facial image data corresponding to the plurality of times (T₁ to Tₙ) with a value representative of the respective state predicted for each of the plurality of times (T₁ to Tₙ), thereby to define labelled facial image data; and
providing the labelled facial image data to the image classifier as training data.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

The embodiments described below refer to analysis of blepharometric data. The term “blepharometric data” refers to data that describes movements of a human subject's eyelid (or eyelids). Eyelid movements are commonly categorised as “blinks” or “partial blinks”. The term “blepharometric data” is used to distinguish technology described herein from other technologies which detect the mere presence of blinks for various purposes (for example detection of blink presence for the purpose of calculating blink rate, rudimentary blink duration, or factors derived therefrom). The technology herein is focused on analysing eyelid movement as a function of time, typically measured as an amplitude. This data may be used to infer the presence of what would traditionally be termed “blinks”, however it is attributes of “events” and other parameters identifiable in eyelid movements which are of primary interest to technologies described herein. These are referred to as “blepharometric artefacts”, with such artefacts being identifiable by application of various processing algorithms to a data set that described eyelid position as a function of time (i.e. blepharometric data). For example, the artefacts may include:
Amplitude to velocity ratio (AVRs);
Negative Inter-Event-Duration (IED);
Positive IED;
Negative AVR;
Positive AVR;
Negative AVR*positive AVR;
Negative AVR divided by positive AVR;
BECD (blink eye closure duration);
Negative DOQ (duration of ocular quiescence);
Positive DOQ;
Relative Amplitude;
Relative Position;
Max Amplitude;
Max Velocity;
Negative ZCI (zero crossing index);
Positive ZCI
Blink start position;
Blink end position;
Blink start time;
Blink end time; and
Trends and changes in any of the above artefacts over a defined period.

In terms of physiological state, there are many factors that have an effect on involuntary blepharometric movements, with examples including: a subject's state of physical activity; a subject's posture; other aspects of a subject's positional state; subject movement; subject activity; how well slept the subject happens to be; levels of intoxication and/or impairment; and others. In terms of brain function, factors that have effects on involuntary blepharometric movements include degenerative brain injuries (e.g. Parkinson's disease) and traumatic brain injuries.

### BRIEF DESCRIPTION OF THE DRAWINGS

Embodiments of the invention will now be described, by way of example only, with reference to the accompanying drawings in which:

FIG. 1 illustrates a system according to one embodiment.

FIG. 2A illustrates a blepharometric detection system according to one embodiment.

FIG. 2B illustrates a blepharometric detection system according to one embodiment.

FIG. 2C illustrates a blepharometric detection system according to one embodiment.

FIG. 3A illustrates a method according to one embodiment.

FIG. 3B illustrates a method according to one embodiment.

### DETAILED DESCRIPTION

The present invention relates, in various embodiments, to prediction human subject states (e.g. physiological and/or psychological and/or neurological) via a hybrid approach, which includes elements of AI-based classification and blepharometric analysis. Embodiments are described by reference to applications in driver alertness monitoring. However, it will be appreciated that the technology is not limited as such, and has application in a broader range of context. For example, the technology is applicable to prediction of physiological states other than alternates level, and to implementation environments other than driver monitoring.

The present technology relates to prediction of human states including any one or more of “physiological” states, “psychological” states and/or “neurological” states. It should be appreciated that blepharometric data analysis may be used to identify a range of states, which fall into one or more of these categories. For example, blepharometric data has been used as a predictor of alertness, drowsiness, intoxication, impairment, attention, disease, and a range of other human states. For the present purposes, the term “physiological” is used as a broad term, with the intention that “physiological” encapsulates states which manifest physiologically and/or neurologically.

In overview, the invention is predicated on the following principles:
Blepharometric analysis (i.e. analysis of eyelid movement as a function of time) provides a reliable and proven technology by which to determine the physiological state of a subject, particularly in the context of alertness/drowsiness.
Image classifier technology (for example AI/neural network type classifiers) present an effective predictive technology which is capable of being implemented using relatively low-cost image capture equipment.

There has been much focus in recent years on the challenge of predicting physiological states of a vehicle operator (again, particularly in the context of alertness/drowsiness). Both blepharometric and image classifier technologies have been used, although in an entirely separate capacity. The former is based on established science, and hence yields more reliable results. The latter is arguably more convenient for implementation in a vehicle environment, and requires a lesser level of processing (for example sample rates for the classifier may be orders of magnitude lower than sample rates required for reliable extraction of blepharometric artefacts).

In known image classifier-based systems, an image classifier is trained based on a database of labelled images, showing subjects in alert states, and drowsy states. These images are typically manually labelled based on a subjective manual review of the images, particularly whether a person “looks” alert or drowsy. With an adequate supply of training images, the classifier should be able to predict, with reasonable accuracy, whether a newly presented facial image shows a person in a drowsy state or an alert state. For optimal accuracy the training images should cover a wide range of demographics, races, ethnicities, ages, and the like.

Technology described herein provides a connection between facial image classification and blepharometric analysis (as used herein, the term “facial image” should be interpreted broadly to include images collected outside the visible light spectrum, including infrared images, ultraviolet images, and the like). In particular, an end-user monitoring system (for example a driver alertness monitoring system) operates using facial image classification technology which is trained and/or validated based on blepharometric analysis. For example:
In some embodiments, facial image data is labelled with physiological condition properties (e.g. alertness/drowsiness level) based on blepharometric artefact analysis performed on data collected with temporal correlation to the facial image data, and that labelled data is used for training of an image classifier.
In some embodiments, facial image data is labelled with physiological condition properties via a process other than blepharometric artefact analysis, and used to train the image classifier. The image classifier is then tested/validated by comparing its results with results obtained via separate blepharometric data analysis.
In some embodiments a hybrid between the above approaches is used. For example, this may include periodic testing of facial image classification predictions against blepharometric artefact analysis, leading to improvement of the classifier training database and/or model.

An example embodiment includes a method of predicting a physiological state of a human subject. The method includes capturing an image frame including a facial region of the subject, and providing the image frame to an image classifier, wherein the image classifier is configured to process the image frame thereby to output a result representative of a predicted physiological state. The image classifier is trained via a process including:
(i) Gathering monitoring data from a plurality of subjects, wherein the monitoring data includes time correlated data representative of: (i) eyelid movement as a function of time; and (ii) facial image data. The eyelid movement data may be collected via image capture equipment (e.g. a digital video capture device), or via alternate hardware (for example a wearable unit configured for infrared reflection oculography purposes, such as sensor enabled spectacles). The eyelid data is optionally for one eye only, and relates to the upper eyelid only.
(ii) Processing the data representative of eyelid movement as a function of time thereby to predict respective physiological states at a plurality of times (T₁ to Tₙ) based on blepharometric artefact analysis. For example, where the physiological states relate to alertness/drowsiness, this may use the Johns Drowsiness Scale (JDS), or other processes/algorithms. Some embodiments make use of analysis of artefacts of individual blink events (e.g. AVRs and the like). Other embodiments make use of analysis aggregate metrics (for example via a technology such as PERCLOS).
(ii) Labelling facial image data corresponding to the plurality of times (T₁ to Tₙ) with a value representative of the respective physiological state predicted for each of the plurality of times (T₁ to Tₙ), thereby to define labelled facial image data. For instance, the value representative of the respective physiological state may be an alertness/drowsiness value (either based on a binary or graduated scale).

Another example embodiment also includes a method of predicting a physiological state of a human subject. This method again includes capturing an image frame including a facial region of the subject, and providing the image frame to an image classifier, wherein the image classifier is configured to process the image frame thereby to output a result representative of a predicted physiological state. However, in the case image classifier is validated against blepharometric data. Training data for the classifier is optionally defined using techniques other than blepharometric artefact analysis, for example including human review and interpretation based on visual characteristics (e.g. “does the subject look drowsy”). The process of testing/validation includes:
(i) Gathering monitoring data from a plurality of subjects, wherein the monitoring data includes time correlated data representative of: (i) eyelid movement as a function of time; and (ii) facial image data.
(ii) Processing the data representative of eyelid movement as a function of time thereby to predict respective physiological states at a plurality of times (T₁ to Tₙ) based on blepharometric artefact analysis.
(iii) Providing facial image data corresponding to the plurality of times (T₁ to Tₙ) to the image classifier, thereby to generate classifier predicted physiological states at the plurality of times (T₁ to Tₙ).
(iv) Comparing the predicted respective physiological states at a plurality of times (T₁ to Tₙ) based on blepharometric artefact analysis with the predicted physiological states at the plurality of times (T₁ to Tₙ), thereby to assess performance of the system.

The process optionally includes model refinement/improvement based on modification of training images and/or adding of new training images based on the results of the comparison process.

Various examples are described below. These are focused on the example of detecting alertness/drowsiness in the context of a vehicle operator monitoring system. As noted, the technology may be applied in the context of other physiological conditions (e.g. susceptibility to a seizure, distraction, stress, intoxication from drugs and/or alcohol, concussion, and others), and additionally the system may also be configured to operate in a context other than vehicle operator monitoring (for example on a smartphone, PC, medical observation environment, or the like). Additionally, although embodiments are described by reference to complex blepharometric analysis based on characteristics of eyelid movement as a function of time, further examples make use of simpler blepharometric analysis, for example blink detection.

Example Technological Framework

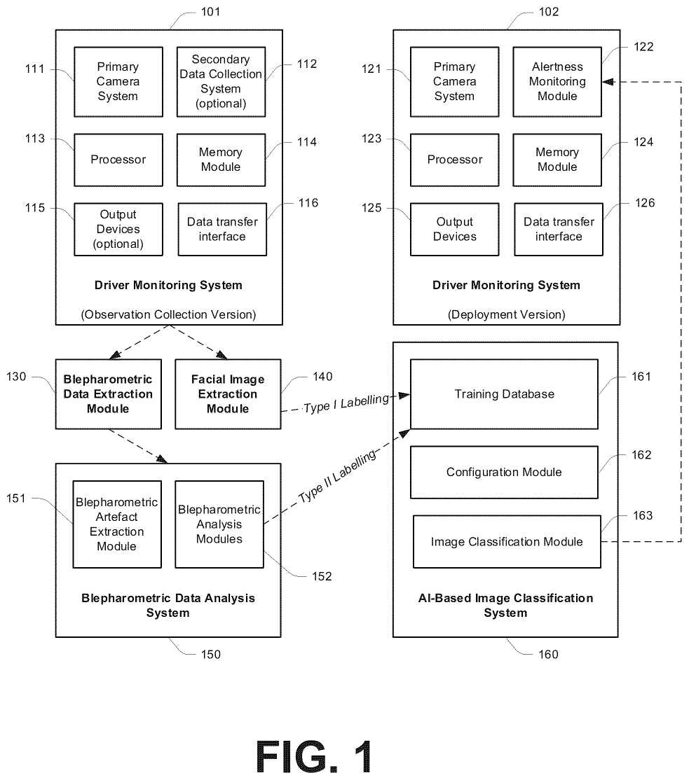

FIG. 1 illustrates a technology framework according to one embodiment. Core components of the framework are as follows:
A driver monitoring system 101, which is illustrated as an “observation collection version”. In practice, the framework includes a plurality of systems such as system 101, which are each configured to collect data from which both facial image data and blepharometric artefact data is able to be extracted, based on monitoring of respective vehicle operators.
A driver monitoring system 102, which is illustrated as a “deployment version”. In practice, the framework includes a plurality of systems such as system 102, which may include systems deployed in vehicles operated by end users, thereby to provide alertness/drowsiness monitoring in those vehicles.
A blepharometric data analysis system 150. This system is configured to perform analysis of blepharometric artefacts, thereby to provide alertness/drowsiness values at defined points in time (based on the same timing reference as used for time-correlated facial image data).
An AI-based image classification system 160. This system is used to enable prediction of alertness/drowsiness based on an input image containing facial image data. The system is trained using a training database 160, which includes a large data set of facial images which are each labelled with an alertness/drowsiness value, and a configuration module which enables configuration (for example tuning) of the model upon which the AI-based classification is based.

System 101 includes a primary camera system 111, which is configured to collect image frames which include a facial region of the vehicle operator when predefined conditions are met (for example when an operator is detected). In some implementations, the image framed captured by primary camera system 111 are captured at a resolution and frame rate which allows for detection and monitoring of eyelid position as a function of time (for example as disclosed in Australian Innovation Patent 2020102426). In other implementations, a secondary data collection system 112 is used for the purposes of collecting observations which enable extraction of blepharometric artefacts. For instance, system 112 may include a further camera system which is better configured to collect image frames from which eyelid movement is able to be tracked. Alternately/additionally, secondary data collection system 112 may include wearable observation hardware, for example infrared reflectance oculography spectacles. It will be appreciated that the use of spectacles may have a perceived downside of obscuring part of the subject's face (hence affecting facial images used for classification purposes). However, in some implementations this is acknowledged as an advantage, in the sense that it allows for training/testing of the image classifier to operate in respect of subjects wearing spectacles (i.e. alertness/drowsiness may be predicted using image classification techniques even if the subject's eyes are obscured by glasses).

System 101 includes a processor 113 and memory module 114 which in combination allow execution of computer executable code, thereby to drive functionalities of the system. These functionalities include: (i) control over collection systems 111 and 112; (ii) storage of collected data in memory module 114, (iii) pre/post processing of that data; (iv) delivering visual/audible outputs via output devices 115; and (v) transfer of observation data from data transfer interface 116 to one or more external devices (for example via a network connection, which may include tethering via a smartphone or the like).

A core function of each system 101 is to provide observation data, collected from vehicle operators, which allows for extraction of time-correlated blepharometric data and facial image data. This is extracted from data collected via system 101 via a blepharometric data extraction module 130 and a facial image extraction module 140. These modules may execute at a variety of locations, and/or have components distributed across multiple locations. For example, data extraction may be performed at any one or more of: (i) within the driver monitoring system; (ii) within a blepharometric data analysis system 150; and (iii) in a system distinct from either of the preceding. In this regard, it will be appreciated that in some implementations it may be preferable to avoid providing facial image data to an operator of system 150.

In the illustrated example, facial image data extracted by module 140 is optionally labelled via “Type I Labelling”, and provided to training database 161. “Type I Labelling” is labelling using factors other then blepharometric analysis, for example subject image visual inspection.

Blepharometric data analysis system 150 receives blepharometric data from module 130, and via an artefact extraction module 151 extracts blepharometric artefacts. The selection of extracted artefacts varies between embodiments, depending at least in part of artefacts which are used as input by algorithms executed via blepharometric analysis modules 152. For example, the artefacts may include any subset of the following:
Amplitude to velocity ratio (AVRs);
Negative Inter-Event-Duration (IED);
Positive IED;
Negative AVR;
Positive AVR;
Negative AVR*positive AVR;
Negative AVR divided by positive AVR;
BECD (blink eye closure duration);
Negative DOQ (duration of ocular quiescence);
Positive DOQ;
Relative Amplitude;
Relative Position;
Max Amplitude;
Max Velocity;
Negative ZCI (zero crossing index);
Positive ZCI
Blink start position;
Blink end position;
Blink start time;
Blink end time;
Blink total duration (BTD);
Blink rates; and
Trends and changes in any of the above artefacts over a defined period.

Training database 161 is then optionally updated via “Type II Labelling”. This in some embodiments includes labelling facial image data in training database 161 based on an alertness/drowsiness metric derived via blepharometric analysis modules 152. In a further implementation rather than providing this data to system 160 for the purposes of labelling images in the training database, the data is provided to system 160 for the purposes of assessing current operation of module 163. The Type II labelling may be binary (alert or drowsy) or graduated (e.g. on a scale of 1 to 10, with 1 being highly alert, and 10 being highly drowsy).

As noted above, driver monitoring systems such as system 102, illustrated as a “deployment version”, are deployed thereby to provide alertness/drowsiness monitoring in vehicles.

System 102 includes a primary camera system 112, which is configured to collect image frames which include a facial region of the vehicle operator when predefined conditions are met (for example when an operator is detected).

System 102 includes a processor 123 and memory module 124 which in combination allow execution of computer executable code, thereby to drive functionalities of the system. These functionalities include: (i) control over collection systems 121; (ii) optional pre-processing of facial image data; (iii) processing of the facial image data via an AI-based image classifier thereby to derive a value representative of alertness/drowsiness (this may include transfer of observation data from data transfer interface 126 to system 160 for cloud processing), via an alertness monitoring module 122; and (iv) delivering visual/audible outputs via output devices 115, for example visual and/or audible alerts when driver fatigue is predicted, based on signals derived from alertness monitoring module 122.

System 101 and system 102 may, in some embodiments, comprise similar or identical hardware (and hence the difference resides in the way the systems are controlled at a software/functional level). The differences between these systems optionally comprise the following:
In some embodiments systems 101 and 102 are identical from a hardware perspective, and the difference is purely in terms of how data is used (and a given system may transition between operation as a system 101 and a system 102). That is, both versions make use of a camera system (111, 121) for the purposes of collecting facial image data and eyelid movement data (which may be extracted from facial image data, for example as disclosed in Australian Innovation Patent 2020102426. The systems optionally captures image data at a different frame rate and/or resolution when being used for the purposes of tracking eyelid movement.
In some embodiments, system 101 includes a secondary data collection system 112, which is separate from primary camera system 111 (being a camera system used to capture facial image data for the purposes of facial image classification. The secondary data collection system 112 includes a secondary camera, which is positioned and/or configured to enable optimised eyelid motion tracking. Additionally/alternately, secondary data collection system 112 may include other forms of eyelid tracking hardware, for example infrared reflection oculography spectacles. It will be appreciated that the use of spectacles for at least some monitoring may be useful in the overall context of the present technology, as it will assist in training/testing an image classifier to detect alertness of a vehicle operator who is wearing glasses/sunglasses.
In some embodiments, system 101 includes a secondary data collection system 112, which is separate from primary camera system 111 (being a camera system used to capture facial image data for the purposes of facial image classification. The secondary data collection system 112 may include other forms of eyelid tracking hardware, for example infrared reflection oculography spectacles.

As noted, it will be appreciated that the use of spectacles for at least some monitoring may be useful in the overall context of the present technology, as it will assist in training/testing an image classifier to detect alertness of a vehicle operator who is wearing glasses/sunglasses. Accordingly, in some embodiments versions of system 101 are used which allow for both camera-based blepharometric data collection and wearable-based blepharometric data collection.

Using the arrangement of FIG. 1, either or both of the following functionalities are able to be achieved:
In some embodiments, facial image data from module 140 is labelled with physiological condition properties (e.g. alertness/drowsiness level) based on blepharometric artefact analysis performed via system 150, and that labelled data is added to training database 161 of system 160 there to enable training of image classification module 163.
In some embodiments, facial image data is labelled with physiological condition properties via Type I labelling (i.e. via a process other than blepharometric artefact analysis), to train the image classifier, and outputs of the image classifier are then tested/validated by comparing its results with results obtained from system 150.

In some embodiments a hybrid between the above approaches is used. For example, this may include periodic testing of facial image classification predictions against blepharometric artefact analysis, leading to improvement of the classifier training database and/or model.

Example Methodology

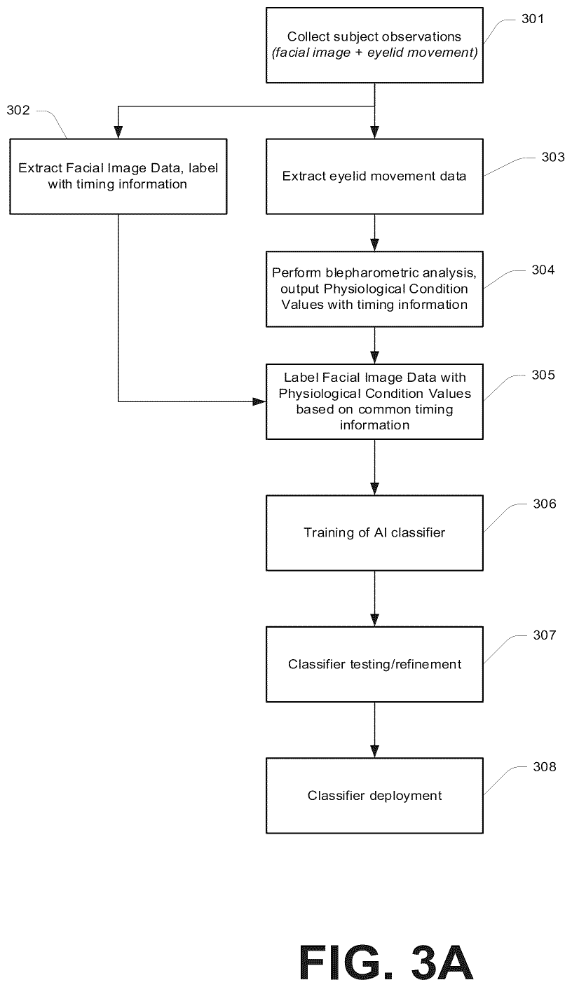

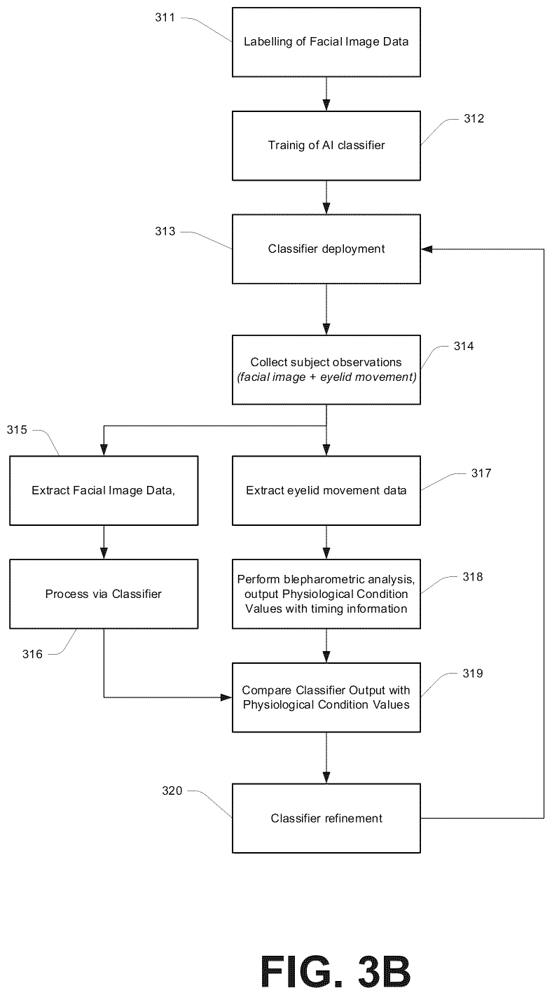

FIG. 3A illustrates an example method according to one embodiment.

Block 301 represents a process including collection of subject observations, including facial images and eyelid movement data. This may be performed via common hardware (e.g. single video camera) or via multiple hardware systems (e.g. multiple video cameras and/or a combination of a video camera and sensor-enabled spectacles).

Block 302 represents a process including extracting of facial image data from the observations, which may include performing one or more data processing techniques in respect of the facial image data, thereby to optimise that data for the purposes of classification. The facial image data is labelled with timing information, based on a timing reference.

Block 303 represents a process including extracting eyelid movement data, for example a data stream which described eyelid position as a function of time, optionally for one eye using the upper eyelid only. In some embodiments this is limited to detecting blinks. In preferred embodiments this includes identifying blepharometric artefacts for individual blinks, including artefacts related to amplitude, velocity and duration (an extended list of optional artefacts is provided further above).

Block 304 represents a process including performing blepharometric analysis thereby to determine and output physiological condition values associated with timing information (based on the same timing reference used in block 302). The physiological condition values may represent a prediction of alertness/drowsiness (e.g. via a JDS algorithm), and/or predictions of other physiological conditions (for example intoxication, attention level, impairment, seizure risk, and others). The value may be defined as a binary value, or based on a graduated scale.

Block 305 represents a process including labelling the facial image data with the physiological condition values (using the timing information, which is able to be correlated relative to a common reference). These labelled images are used to train an AI classifier at block 306. The images are additionally preferably labelled with additional information, for example ethnicity/gender/age details, and/or other details relating to the subject.

Block 307 represents a process including classifier testing and refinement. This may include providing new facial image data to the classifier, thereby to generate a prediction of a physiological condition (“new” in the sense that the image has never been provided to the classifier before). A blepharometric analysis-based prediction of a physiological condition has been determined. The output of the classifier is compared with the blepharometric analysis based prediction thereby to test the effectiveness of the classifier. The classifier may be modified (for example via configuration and/or additional training) as a result. This process is continued until such a time as the classifier reliably provides outputs from new facial image data which confirm with the blepharometric analysis. Once the classifier demonstrates sufficient accuracy, it is deployed at block 308 (for example made available for use via end-user monitoring systems, such as vehicle operator monitoring systems).

FIG. 3B illustrates a method according to a further embodiment.

In this example, blocks 311 and 312 represent a process whereby facial mage data is labelled with predicted physiological conditions thereby to train an AI image classifier. The labelling includes a value representative of the physiological condition (which bay be an alertness/drowsiness condition), and optionally other characteristics of the subject. The classifier is then deployed for testing at block 313.

Testing the classifier includes:
Collecting observations at block 314, and from those observations extracting facial image data (block 315) which is processed via the classifier (block 316). This results in a classifier-based prediction of physiological state.
Also from the observations collected at block 314, extracting eyelid movement data (block 317) and performing blepharometric analysis thereby to derive a blepharometric-based prediction of physiological state (block 318).

Block 319 represents a process including comparing output from the classifier with output from the blepharometric analysis. If there is inconsistency in the outcomes, the classifier is refined at 320, and re-deployed for further testing at block 313.

Example Spectacles-Based Hardware Configuration

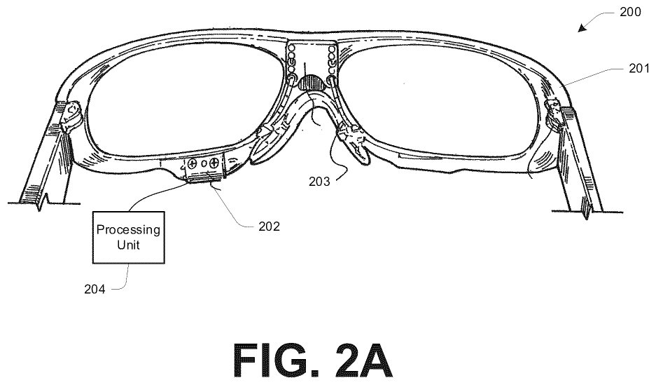

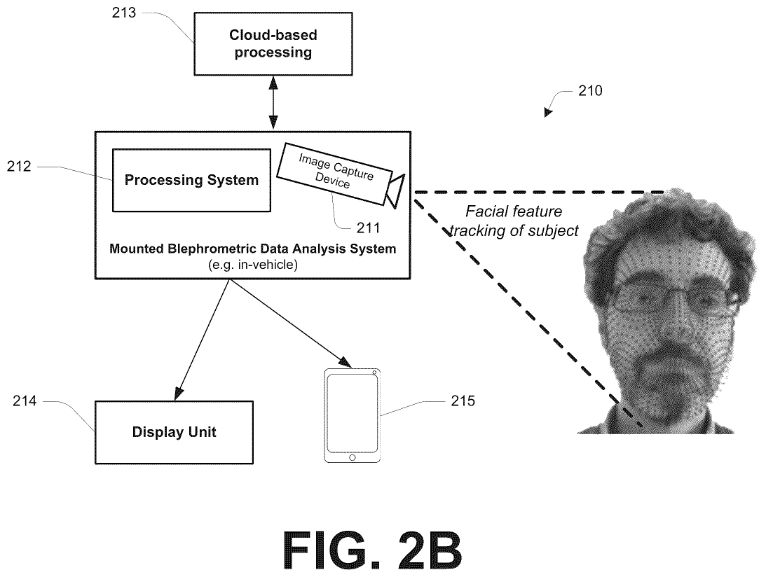

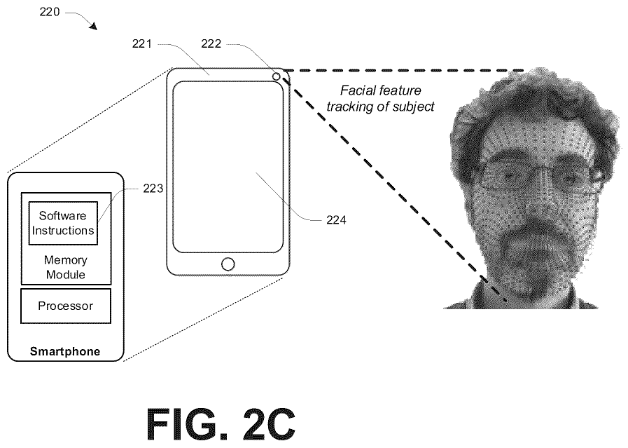

FIG. 2A illustrates a first example hardware arrangement for collection of eyelid movement data, in the form of a head wearable unit, which in the example of FIG. 2A takes the form spectacles 200.

These spectacles need not be functional as vision affecting spectacles (i.e. they do not necessarily include lenses, and may simply be a frame that provides a wearable mount, or other head-wearable device). Spectacles 200 include a frame 201 which is mounted to a human subject's head, an IR transmitter/receiver assembly 202 which is positioned relative to the body thereby to, in use, transmit a predefined IR signal onto the subject's eye, and receive a reflected IR signal resulting from reflection of the transmitted IR signal off the user's eye or eyelid. A sizing adjustment mechanism 203 allows for control over positioning of a nose mount portion, thereby to allow effective locating of assembly 202 relative to the wearer's eye. A processing unit 204 (which is optionally mounted to a spectacle arm) receives and processes the received IR signal. This processing may include:
Onboard processing, using a set of artefact detection algorithms stored a computer code on a memory unit and executed via a microprocessor. For example, raw data from IR assembly 202 is subjected to one or more pre-processing algorithms (for example filters and the like), and an artefact detection algorithm operates to identify the presence of defined data artefacts, and provide an output signal in the case that those defined data artefacts are identified.
External processing, via a secondary processing device. In this case, raw data from IR assembly 202 is transmitted (for example via Bluetooth or another wireless communication medium) to a secondary processing device, which optionally takes the form of a smartphone. In some embodiments an onboard processor performs preliminary processing of the raw data prior to transmission, for example to reduce complexity and/or amount of data required to be transmitted. The secondary processing device executes a software application which includes/accesses the set of artefact detection algorithm (which are stored on a memory unit of the secondary processing device). Again, these algorithms operate to identify the presence of defined data artefacts, and provide an output signal in the case that those defined data artefacts are identified.

In both cases, there is an optional functionality whereby all or a subset of data is collected for transmission or transmitted in real-time to a server device for further analysis.

Example Camera-Based Hardware Configuration

FIG. 2B illustrates a second example hardware arrangement, in the form of a camera-based blepharometric data monitoring system 210.

System 210 includes a camera unit 211, which is positioned to capture image data in a region including a human subject's face, when that human subject is positioned in a defined area. For example, in some cases the defined area is an operator position for a vehicle (such as a car or truck, airline, or other, including operator and/or passenger locations). In other embodiments the defined area is relative to a piece of furniture (for example to allow monitoring of a subject operating a computer or watching a television), or a clinical device. The camera unit may include a webcam provided by a computer device. A processing unit 212 processes image data from camera unit 211 via a vision system thereby to identify a subject's facial region (for example using known facial detection algorithms), and from that identify the user's eyes, and by way of image-driven tracking algorithms monitor the user's eyes thereby to detect and measure blinks (optionally in combination with cloud-based processing 213). Blinks are identified and measured thereby to determine blepharometric data, which is processed using artefact detection algorithms, for example as discussed above. Once again, these algorithms operate to identify the presence of defined data artefacts, and provide an output signal in the case that those defined data artefacts are identified.

By way of example, in some embodiments the hardware arrangement of FIG. 2B is installed in a vehicle, such as an automobile, and as such configured to detect artefacts in blepharometric data which are relevant to an operator of the vehicle (for example in the context of detecting drowsiness and/or other neurological conditions).

Output, for example in terms of alerts and the like, is delivered via an output unit such as a display device 214 (which, in a vehicle embodiment, may be an in-vehicle display) or a networked computing device (such as a smartphone 215). In some embodiments delivery of data to an output device is provided from an Internet-based processing/data management facility to the display device rather than directly from system 212 (e.g. both are connected to a common networked data processing/management system). The output may be delivered to the human subject being monitored and/or to a third party.

In some embodiments, eyelid monitoring is performed via a process including the following steps, thereby to provide a signal representative of amplitude as a function of time.
(i) Identify that a human face is detected.
(ii) In a detected human face, identifying an eye region. In some embodiments, algorithms are configured to track one eye region only; in other embodiments both eye regions are tracked thereby to improve data collection.
(iii) Identify, in the eye region(s), presence and movement of an eyelid. For example, in a preferred embodiment this is achieved by way of recording an eyelid position relative to a defined “open” position against time. This allows generation of blepharometric data in the form of eyelid position (amplitude) over time. It will be appreciated that such data provides for identification of events (for example blink events) and velocity (for example as a first derivative of position against time). In a preferred embodiment, a facial recognition algorithm is used to enable identification of: (i) a central position on an upper eyelid on a detected face; and (ii) at least two fixed points on the detected face. The two fixed points on the detected face are used to enable scaling of measurements of movement of the central position of the upper eyelid thereby to account to changes in relative distance between the user and the camera. That is, a distance between the two fixed points is used as a means to determine position of the face relative to the camera, including position by reference to distance from the camera (as the user moves away, the distance between the fixed points decreases).

It will be appreciated that other techniques may be used. For example, in one embodiment a trained AI image classifier is used to identify blink commencement and completion events from images, for example based on a pre-training process.

Example Smartphone-Based Hardware Configuration

FIG. 2C illustrates a third blepharometric monitoring system, in the form of a smartphone-integrated blepharometric monitoring system 220.

From a hardware perspective, system 220 utilises existing smartphone hardware 221. A smartphone image capture unit (preferably a front-facing camera 222, but optionally a rear facing camera) is leveraged by a software application 223 thereby to perform facial detection and blepharometric detection/measurement in a similar manner to the embodiment of FIG. 2B. In some embodiments the software application operates as a foreground application, which delivers graphical information via the smartphone screen 224 concurrently with blink detection (in some cases this graphical information is used to assist in standardising conditions for a blink detection period). In other embodiments the software application operates as a background application, which perform blink detection and measurement whilst other software applications are presented as foreground applications (for example blink detection whilst a user operates a messaging application). Processing of blink detection data is optionally performed via software application 223 using the smartphone's internal processing capabilities, transmitted to a server device for remote processing, or a hybrid approach which includes both local processing and remote processing.

Similar to the example of FIG. 2C, one embodiment provides a portable electronic device including: a display screen; and a front-facing camera; wherein the portable electronic device is configured to concurrently execute: (i) a first software application that provides data via the display screen; and (ii) a second software application that receives input from the front facing camera thereby to facilitate detection and analysis if blepharometric data. For example, the first software application is in one embodiment a messaging application, and in another embodiment a social media application. This allows for collection of blepharometric data whilst a user engages in conventional mobile device activities.

One embodiment provides computer executable code that when executed causes delivery via a computing device of a software application with which a user interacts for a purpose other than blepharometric-based data collection, wherein the computer executable code is additionally configured to collect data from a front-facing camera thereby to facilitate analysis of blepharometric data. The purpose may be, for example, messaging or social media.

Embodiments such as that of FIG. 2C provide for collection of blepharometric data via a background software application executing on electronic device with a front-facing camera. This provides opportunities to analyse a device user's neurological condition, for example in the context of predicting seizures, advising on activities, diagnosing potential neurological illnesses, detecting drowsiness, and so on.

### CONCLUSIONS AND INTERPRETATION

It will be appreciated that the above disclosure provides analytic methods and associated technology that enables improved prediction of human physiological states. In particular, these provide a hybrid between blepharometric methods, which have proven reliability, and image classifier methods, which are more convenient to deploy in certain environments (for example vehicle operator monitoring).

It should be appreciated that in the above de scription of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

What is claimed is:

1. A method of predicting a state of a human subject, the method including:
capturing an image frame including a facial region of the subject; and
providing the image frame to an image classifier, wherein the image classifier is configured to process the image frame thereby to output a result representative of a predicted state;
wherein the image classifier is trained via a process including:
gathering monitoring data from a plurality of subjects, wherein the monitoring data includes time correlated data representative of: (i) eyelid movement; and (ii) facial image data;
processing the data representative of eyelid movement as a function of time thereby to predict respective states at a plurality of times (T₁ to Tₙ) based on eyelid movement analysis;
labelling facial image data corresponding to the plurality of times (T₁ to Tₙ) with a value representative of the respective state predicted for each of the plurality of times (T₁ to Tₙ), thereby to define labelled facial image data; and
providing the labelled facial image data to the image classifier as training data.

2. A method according to claim 1 wherein the data representative of eyelid movement is representative of eyelid position as a function of time.

3. A method according to claim 1 wherein the eyelid movement analysis is blepharometric artefact analysis.

4. A method according to claim 1 wherein the states are states relating to a condition of alertness or drowsiness.

5. (canceled)

6. A method according to claim 1, wherein the monitoring data is collected from subjects engaged in a predefined activity, and wherein the step of capturing an image frame including a facial region of the subject is performed in respect of a subject engaging in the same form of predefined activity.

7. (canceled)

8. (canceled)

9. A method according to claim 1, wherein the data representative of eyelid movement is data representative of eyelid movement as a function of time and includes video data, from which eyelid position as a function of time is extracted via image processing techniques.

10. A method according to claim 1, wherein the data representative of eyelid movement is data representative of eyelid movement as a function of time and includes data derived from eyelid monitoring hardware.

11. (canceled)

12. A method according to claim 1, wherein the analysis of eyelid movement is blepharometric artefact analysis and makes use of a subset of the following blepharometric artefacts:
Amplitude to velocity ratio (AVRs);
Negative Inter-Event-Duration (IED);
Positive IED;
Negative AVR;
Positive AVR;
Negative AVR*positive AVR;
Negative AVR divided by positive AVR;
BECD (blink eye closure duration);
Negative DOQ (duration of ocular quiescence),
Positive DOQ;
Relative Amplitude;
Relative Position;
Max Amplitude;
Max Velocity,
Negative ZCI (zero crossing index);
Positive ZCI
Blink start position;
Blink end position;
Blink start time;
Blink end time; and
Trends and changes in any of the above artefacts over a defined period.

13. A method of training a system configured to predict a state of a human subject, wherein the system is configured to perform a method including:
capturing an image frame including a facial region of the subject; and
providing the image frame to an image classifier, wherein the image classifier is configured to process the image frame thereby to output a result representative of a predicted state;
the method including:
gathering monitoring data from a plurality of subjects, wherein the monitoring data includes time correlated data representative of: (i) eyelid movement; and (ii) facial image data;
processing the data representative of eyelid movement as a function of time thereby to predict respective states at a plurality of times (T₁ to Tₙ) based on eyelid movement analysis;
labelling facial image data corresponding to the plurality of times (T₁ to Tₙ) with a value representative of the respective state predicted for each of the plurality of times (T₁ to Tₙ), thereby to define labelled facial image data; and
providing the labelled facial image data to the image classifier as training data.

14. A method according to claim 13 wherein the data representative of eyelid movement is representative of eyelid position as a function of time.

15. A method according to claim 13 wherein the eyelid movement analysis is blepharometric artefact analysis.

16. A method according to claim 13, wherein the states are states relating to a condition of alertness or drowsiness.

17. (canceled)

18. A method according to claim 13, wherein the monitoring data is collected from subjects engaged in a predefined activity, and wherein the step of capturing an image frame including a facial region of the subject is performed in respect of a subject engaging in the same form of predefined activity.

19. (canceled)

20. A method according to claim 18, wherein the predefined activity is operating a vehicle.

21. A method according to claim 13, wherein the data representative of eyelid movement is data representative of eyelid movement as a function of time and includes video data, from which eyelid position as a function of time is extracted via image processing techniques.

22. A method according to claim 13, wherein the data representative of eyelid movement is data representative of eyelid movement as a function of time and includes data derived from eyelid monitoring hardware.

23. A method according to claim 22 wherein the eyelid monitoring hardware utilised infrared reflectance oculography.

24. A method according to claim 13, wherein the analysis of eyelid movement is blepharometric artefact analysis and makes use of a subset of the following blepharometric artefacts:
Amplitude to velocity ratio (AVRs);
Negative Inter-Event-Duration (IED);
Positive IED;
Negative AVR;
Positive AVR,
Negative AVR*positive AVR;
Negative AVR divided by positive AVR;
BECD (blink eye closure duration);
Negative DOQ (duration of ocular quiescence);
Positive DOQ;
Relative Amplitude;
Relative Position;
Max Amplitude;
Max Velocity;
Negative ZCI (zero crossing index);
Positive ZCI
Blink start position;
Blink end position;
Blink start time;
Blink end time; and
Trends and changes in any of the above artefacts over a defined period.

25. A method of assessing performance of a system configured to predict a state of a human subject, wherein the system is configured to perform a method including:
capturing an image frame including a facial region of the subject; and
providing the image frame to an image classifier, wherein the image classifier is configured to process the image frame thereby to output a result representative of a predicted state;
the method including:
gathering monitoring data from a plurality of subjects, wherein the monitoring data includes time correlated data representative of: (i) eyelid movement; and (ii) facial image data;
processing the data representative of eyelid movement as a function of time thereby to predict respective states at a plurality of times (T₁ to Tₙ) based on eyelid movement analysis;
providing facial image data corresponding to the plurality of times (T₁ to Tₙ) to the image classifier, thereby to generate classifier predicted states at the plurality of times (T₁ to Tₙ);
comparing the predicted respective states at a plurality of times (T₁ to Tₙ) based on blepharometric artefact analysis with the predicted states at the plurality of times (T₁ to Tₙ), thereby to assess performance of the system.

26-52. (canceled)
